(19) United States
(12) Patent Application Publication
(10) Pub. No.: US 2021/0065648 A1
(43) Pub. Date: Mar. 4, 2021

(54) DISPLAY APPARATUS AND METHOD OF DRIVING THE SAME

(71) Applicant: Samsung Display Co., Ltd., Yongin-Si (KR)

(72) Inventors: Sungsoo CHOI, Anyang-si (KR); Song Yi HAN, Asan-si (KR); Gwangsoo AHN, Suwon-si (KR)

(21) Appl. No.: 16/889,666

(22) Filed: Jun. 1, 2020

(30) Foreign Application Priority Data
Sep. 2, 2019 (KR) 10-2019-0108350

(51) Int. Cl. G09G 3/36

(52) U.S. Cl. CPC G09G 3/3696; G09G 2310/08; G09G 3/3688

(57) ABSTRACT

A display apparatus includes a display panel, a gate driver, a data driver, and a power voltage generator. The power voltage generator provides a power voltage to at least one of the display panel, the gate driver, and the data driver. The power voltage generator generates a gate-on voltage, a gate-off voltage, and a gate clock signal toggling between the gate-on voltage and the gate-off voltage. The power voltage generator detects a voltage level of the gate clock signal before toggling the gate clock signal and after turning on the display apparatus and changes a supply pattern of the power voltage based on the gate clock signal having a first abnormal voltage level out of a first predetermined normal range.

### PRIORITY STATEMENT

This application claims priority under 35 U.S.C. § 119 to Korean Patent Application No. 10-2019-0108350, filed on Sep. 2, 2019 in the Korean Intellectual Property Office KIPO, the disclosure of which is herein incorporated by reference in its entirety.

### BACKGROUND

### 1. Field

Example embodiments of the present inventive concept relate to a display apparatus and a method of driving the display apparatus. More particularly, example embodiments of the present inventive concept relate to a display apparatus that is capable of detecting a short circuit between a gate line and a common electrode, thereby enhancing a stability and a reliability and a method of driving the display apparatus.

### 2. Description of the Related Art

Generally, a display apparatus includes a display panel and a display panel driver. The display panel displays an image based on an input image data. The display panel includes a plurality of gate lines, a plurality of data lines, and a plurality of pixels. The display panel driver includes a gate driver for providing gate signals to the gate lines, a data driver for providing data voltages to the data lines, a driving controller for controlling the gate driver and the data driver, and a power voltage generator for providing power voltages to the display panel, the gate driver, and the data driver.

A short circuit between signal transmitting lines in a portion of the display apparatus may cause heat, fire, a bodily injury, or a property damage to a user of the display apparatus.

### SUMMARY

Example embodiments of the present inventive concept provide a display apparatus capable of sensitively detecting a short circuit between gate lines or a short circuit between a gate line and a common electrode to enhance a stability and a reliability of the display apparatus.

Some of the example embodiments of the present inventive concept provide a method of driving such a display apparatus.

In an example embodiment of a display apparatus according to the present inventive concept, the display apparatus includes a display panel, a gate driver, a data driver and a power voltage generator. The display panel includes a gate line and a data line. The gate driver is connected to the gate line. The data driver is connected to the data line. The power voltage generator is configured to provide a power voltage to at least one of the display panel, the gate driver and the data driver. The power voltage generator is further configured to generate, a gate-on voltage, a gate-off voltage and a gate clock signal toggling between the gate-on voltage and the gate-off voltage. The power voltage generator is further configured to detect a voltage level of the gate clock signal before toggling the gate clock signal and after turning on the display apparatus change a supply pattern of the power voltage based on the gate clock signal having a first abnormal voltage level out of a first predetermined normal range.

In an example embodiment, the power voltage generator may be further configured to detect the voltage level of the gate clock signal after the display apparatus is turned on and after a common voltage applied to the display panel increases from an initial voltage level, and the gate clock signal decreases from the initial voltage level to a first voltage level lower than the initial voltage level.

In an example embodiment, the power voltage generator may be further configured to decrease the gate-off voltage in a first start period, maintain a voltage level of the gate-off voltage in a first delay period, increase the gate-on voltage to an input voltage in a second start period, increase an analog high voltage and the common voltage in a third start period, and maintain voltage levels of the analog high voltage and the common voltage in a second delay period. The power voltage generator may be further configured to detect the voltage level of the gate clock signal in the second delay period.

In an example embodiment, the power voltage generator may be further configured to detect the voltage level of the gate clock signal after decreasing the gate clock signal from the initial voltage level to the first voltage level. The power voltage generator may be further configured to increase the gate clock signal from the first voltage level to a voltage second level that is higher than the first voltage level and lower than the initial voltage level after detecting the voltage level of the gate clock signal.

In an example embodiment, the power voltage generator may be further configured to increase the gate-on voltage from the input voltage to a target voltage level in a fourth start period and maintain the target voltage level of the gate-on voltage in a third delay period. The power voltage generator may be further configured to increase the gate clock signal from the first voltage level to the second voltage level in the third delay period.

In an example embodiment, the power voltage generator may be further configured to detect the voltage level of the gate clock signal using a current flow through the gate line.

In an example embodiment, the power voltage generator may be further configured to detect the voltage level of the gate clock signal after a rising edge of the gate clock signal and after a falling edge of the gate clock signal after the gate clock signal starts toggling.

In an example embodiment, the power voltage generator may be further configured to detect a status of the gate clock signal after the rising edge of the gate clock signal and after the falling edge of the gate clock signal based on a gate clock current flowing through the gate line.

In an example embodiment, the power voltage generator may be further configured to detect the voltage level of the gate clock signal right before the rising edge of the gate clock signal and right before the falling edge of the gate clock signal after the gate clock signal starts toggling.

In an example embodiment, the power voltage generator may be further configured to determine whether a gate clock current flowing through the gate line is less than a normal-off voltage level right before the rising edge of the gate clock signal.

In an example embodiment, the power voltage generator may be further configured to determine whether the gate clock current is greater than the normal-off voltage level right before the falling edge of the gate clock signal.

In an example embodiment, the power voltage generator may be further configured to generate a second gate-off voltage greater than the gate-off voltage. The power voltage generator may be further configured to change a supply pattern of the power voltage based on the second gate-off voltage having a second abnormal voltage level out of a second predetermined normal range.

In an example embodiment, the power voltage generator may be further configured to detect a voltage level of the second gate-off voltage after the display apparatus is turned on and after a common voltage applied to the display panel increases from an initial voltage level, and the second gate-off voltage decreases from the initial voltage level to a first voltage level lower than the initial voltage level.

In an example embodiment, the power voltage generator may be further configured to decrease the gate-off voltage in a first start period, maintain a voltage level of the gate-off voltage in a first delay period, increase the gate-on voltage to an input voltage in a second start period, increase an analog high voltage and the common voltage in a third start period, and maintain voltage levels of the analog high voltage and the common voltage in a second delay period. The power voltage generator may be configured to detect the voltage level of the second gate-off voltage in the second delay period.

In an example embodiment, the power voltage generator may be further configured to detect the voltage level of the second gate-off voltage after decreasing the second gate-off voltage from the initial voltage level to a third voltage level. The power voltage generator may be further configured to increase the second gate-off voltage from the third voltage level to a fourth voltage level that is higher than the third voltage level and lower than the initial voltage level after detecting the voltage level of the second gate-off voltage.

In an example embodiment, the power voltage generator may be further configured to increase the gate-on voltage from the input voltage to a target voltage level in a fourth start period and maintain the target voltage level of the gate-on voltage in a third delay period. The power voltage generator may be further configured to increase the second gate-off voltage from the third voltage level to the fourth voltage level in the third delay period.

In an example embodiment, the power voltage generator may be further configured to detect the voltage level of the second gate-off voltage using a current flow through an applying line of the second gate-off voltage in the gate driver.

In an example embodiment of a method of driving a display apparatus, the method includes generating a gate-on voltage, generating a gate-off voltage, generating a gate clock signal toggling between the gate-on voltage and the gate-off voltage, detecting a voltage level of the gate clock signal before toggling the gate clock signal and after turning on the display apparatus and changing a pattern of a power supply of the display apparatus based on the gate clock signal having an abnormal voltage level out of a predetermined normal range.

In an example embodiment, the voltage level of the gate clock signal may be detected after the display apparatus is turned on and after a common voltage applied to a display panel of the display apparatus increases from an initial voltage level, and the gate clock signal decreases from the initial voltage level.

In an example embodiment, the method may further including decreasing the gate-off voltage in a first start period, maintaining a voltage level of the gate-off voltage in a first delay period, increasing the gate-on voltage to an input voltage in a second start period, increasing an analog high voltage and the common voltage in a third start period, and maintain voltage levels of the analog high voltage and the common voltage in a second delay period. The voltage level of the gate clock signal may be detected in the second delay period.

According to the display apparatus and the method of driving the display apparatus, a voltage level of the gate clock signal is firstly detected before toggling the gate clock signal and after turning on the display apparatus so that an abnormal voltage level of the gate clock signal may be sensitively detected. The detected abnormal voltage level of the gate clock signal may indicate presence of a short circuit, and it may be used to prevent heat and/or fire by changing a supply pattern of a power voltage to the display apparatus.

In addition, the abnormal voltage level of the gate clock signal may be secondly and thirdly detected after toggling the gate clock signal.

### BRIEF DESCRIPTION OF THE DRAWINGS

The above and other features and advantages of the present inventive concept will become more apparent by describing in detailed example embodiments thereof with reference to the accompanying drawings, in which:

FIG. 1 is a block diagram illustrating a display apparatus according to an example embodiment of the present inventive concept;

FIG. 2 is a cross-sectional view illustrating parts of a first base substrate and a second base substrate of the display panel of FIG. 1;

FIG. 3 is a timing diagram illustrating an input voltage and an output voltage of a power voltage generator of FIG. 1;

FIG. 4 is a timing diagram illustrating the input voltage, the output voltage, and a detected current of the power voltage generator of FIG. 1;

FIG. 5 is a timing diagram illustrating gate clock control signals, gate clock signals, and gate currents of a gate driver of FIG. 1;

FIG. 6 is a timing diagram illustrating an input voltage and an output voltage of a power voltage generator of a display apparatus according to an example embodiment of the present inventive concept; and

FIG. 7 is a timing diagram illustrating the input voltage, the output voltage and a detected current of the power voltage generator of FIG. 6.

### DETAILED DESCRIPTION OF THE INVENTIVE CONCEPT

Hereinafter, the present inventive concept will be explained in detail with reference to the accompanying drawings.

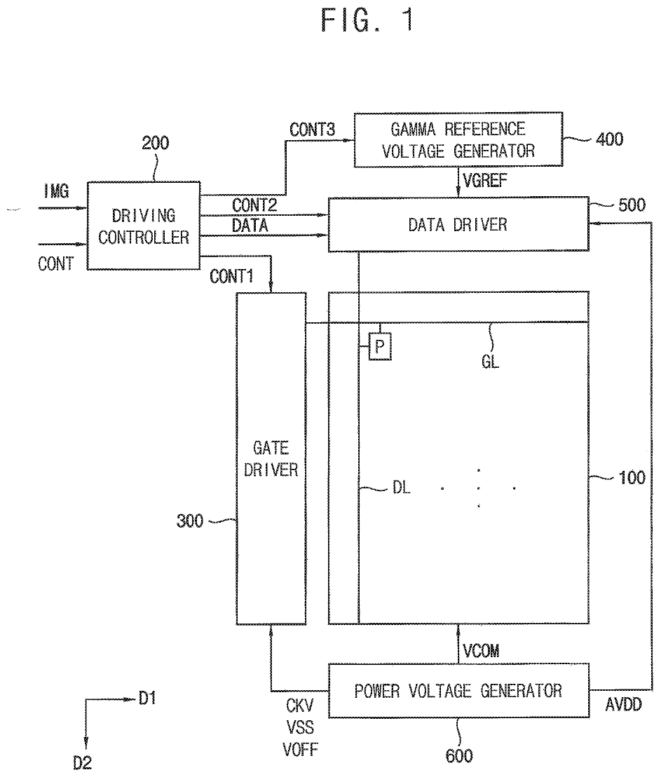

FIG. 1 is a block diagram illustrating a display apparatus according to an example embodiment of the present inventive concept.

Referring to FIG. 1, the display apparatus includes a display panel 100 and a display panel driver. The display panel driver includes a driving controller 200, a gate driver 300, a gamma reference voltage generator 400, and a data driver 500. The display panel driver may further include a power voltage generator 600.

In one embodiment, the driving controller 200 and the data driver 500 may be integrally formed. In another embodiment, the driving controller 200, the gamma reference voltage generator 400, and the data driver 500 may be integrally formed. A driving module integrally including at least the driving controller 200 and the data driver 500 may be referred to as a timing controller embedded data driver (TED).

The display panel 100 has a display region in which an image is displayed and a peripheral region adjacent to the display region.

The display panel 100 includes a plurality of gate lines GL, a plurality of data lines DL, and a plurality of pixels P, and each pixel P is connected to corresponding ones of the gate lines GL and the data lines DL, respectively. The gate lines GL extend in a first direction D1, and the data lines DL extend in a second direction D2 crossing the first direction D1.

The driving controller 200 receives input image data IMG and an input control signal CONT from an external apparatus (not shown). In one embodiment, the input image data IMG may include red image data, green image data, and blue image data. The input image data IMG may include white image data in addition to the red, green, and blue image data. In another embodiment, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, and a data signal DATA based on the input image data IMG and the input control signal CONT.

The driving controller 200 generates the first control signal CONT1 for controlling an operation of the gate driver 300 based on the input control signal CONT and outputs the first control signal CONT1 to the gate driver 300. The first control signal CONT1 may further include a vertical start signal and a gate clock control signal.

The driving controller 200 generates the second control signal CONT2 for controlling an operation of the data driver 500 based on the input control signal CONT and outputs the second control signal CONT2 to the data driver 500. The second control signal CONT2 may include a horizontal start signal and a load signal.

The driving controller 200 generates the data signal DATA based on the input image data IMG and outputs the data signal DATA to the data driver 500.

The driving controller 200 generates the third control signal CONT3 for controlling an operation of the gamma reference voltage generator 400 based on the input control signal CONT and outputs the third control signal CONT3 to the gamma reference voltage generator 400.

The gate driver 300 generates gate signals that drive the gate lines GL in response to the first control signal CONT1 that is received from the driving controller 200. The gate driver 300 outputs the gate signals to the gate lines GL. The gate driver 300 may sequentially output the gate signals to the gate lines GL. In one embodiment, the gate driver 300 may be mounted or integrated on a peripheral region of the display panel 100.

The gamma reference voltage generator 400 generates a gamma reference voltage VGREF in response to the third control signal CONT3 that is received from the driving controller 200. The gamma reference voltage generator 400 provides the gamma reference voltage VGREF to the data driver 500. The gamma reference voltage VGREF may have a value corresponding to a level of the data signal DATA.

In an example embodiment, the gamma reference voltage generator 400 may be disposed in the driving controller 200 or in the data driver 500.

The data driver 500 receives the second control signal CONT2 and the data signal DATA from the driving controller 200 and the gamma reference voltages VGREF from the gamma reference voltage generator 400. The data driver 500 converts the data signal DATA into data voltages as an analog signal using the gamma reference voltages VGREF. The data driver 500 outputs the data voltages to the data lines DL. In one embodiment, the data driver 500 may be mounted or integrated on a peripheral region of the display panel 100.

The power voltage generator 600 may provide a power voltage to at least one of the display panel 100, the driving controller 200, the gate driver 300, the gamma reference voltage generator 400, and the data driver 500. In one embodiment, the power voltage generator 600 may include a DC-to-DC converter.

For example, the power voltage generator 600 may generate a common voltage VCOM and outputs the common voltage VCOM to the display panel 100. In the present example embodiment, the display apparatus may be a liquid crystal display apparatus including a liquid crystal layer. However, the display apparatus of the present inventive concept may not be limited to the liquid crystal display apparatus, and the display apparatus described herein may be other types of display apparatus including, but not limited to, a plasma display apparatus and an organic light emitting display apparatus.

In one embodiment, the power voltage generator 600 may generate a gate clock signal CKV used for generating the gate signals, a gate-off voltage VOFF, and a second gate-off voltage VSS controlling an operation of the gate driver 300 and output the gate clock signal CKV, the gate-off voltage VOFF, and the second gate-off voltage VSS to the gate driver 300.

The power voltage generator 600 may further generate an analog high voltage AVDD determining a level of the data voltage and output the analog high voltage AVDD to the data driver 500.

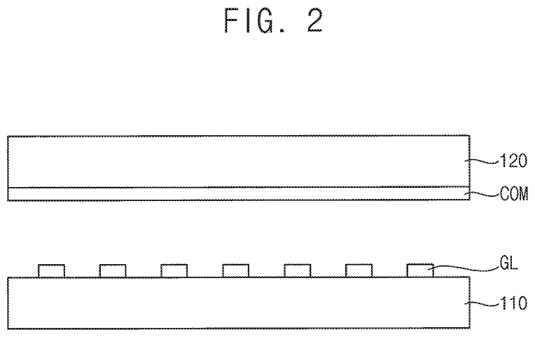

FIG. 2 is a cross-sectional view illustrating parts of a first base substrate and a second base substrate of the display panel 100 of FIG. 1.

Referring to FIGS. 1 and 2, the display panel 100 may include a first base substrate 110 on which the gate lines GL are disposed and a second base substrate 120 on which a common electrode COM is disposed. Although not shown in FIGS. 1 and 2, a liquid crystal layer may be disposed between the first base substrate 110 and the second base substrate 120. In FIG. 2, only some of elements of the first base substrate 110 and the second base substrate 120 are illustrated for convenience of explanation.

A short circuit may occur between adjacent gate lines GL or between the gate line GL and the common electrode COM due to a defect in a manufacturing process of the display apparatus or a damage in use. The short circuit between adjacent gate lines GL or between the gate line GL and the common electrode COM may result in excessive heat or even fire of the display apparatus.

According one embodiment, the display apparatus may change a pattern of a power supply after determining presence of the short circuit between adjacent gate lines GL or between the gate line GL and the common electrode COM. In one embodiment, the power voltage generator 600 may entirely stop providing power to at least one of the display panel 100, the gate driver 300, and the data driver 500 after detecting a short circuit. In another embodiment, the power voltage generator 600 may selectively provide power to at least one of the display panel 100, the gate driver 300, and the data driver 500 after detecting a short circuit. In yet another embodiment, the power voltage generator 600 may lower the voltage level of a power voltage provided to at least one of the display panel 100, the gate driver 300, and the data driver 500 after detecting a short circuit.

Although the common voltage VCOM that is applied to the common electrode COM is a direct current (DC) level, the DC level of the common voltage VCOM may be increased or decreased due to a coupling between the common voltage VCOM and the data voltage. For example, when the data voltage toggles between a high level and a low level according to a display image pattern displayed on the display panel 100, the common voltage VCOM may toggle due to the coupling between the common voltage VCOM and the data voltage.

When the common voltage VCOM toggles, the level of the gate clock signal CKV or the level of the gate signal may be perturbed due to the coupling between the common electrode COM and the gate line GL.

Although the short circuit may not occur between the gate lines GL or between the gate line GL and the common electrode COM, the level of the gate clock signal CKV may be perturbed due to the coupling between the common electrode COM and the gate line GL. Herein, the perturbed level of the gate clock signal CKV due to the coupling between the common electrode COM and the gate line GL may be within a normal range. Therefore, a threshold value used for detecting a short circuit between adjacent gate lines GL may be set higher than the normal range due to the perturbed level of the gate clock signal CKV after the toggle of the gate clock signal CKV and/or the toggle of the data voltage.

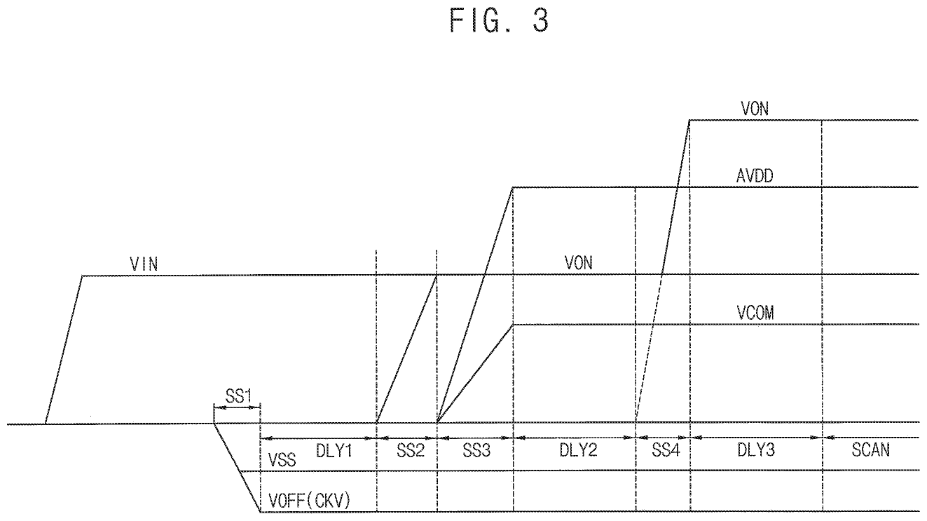

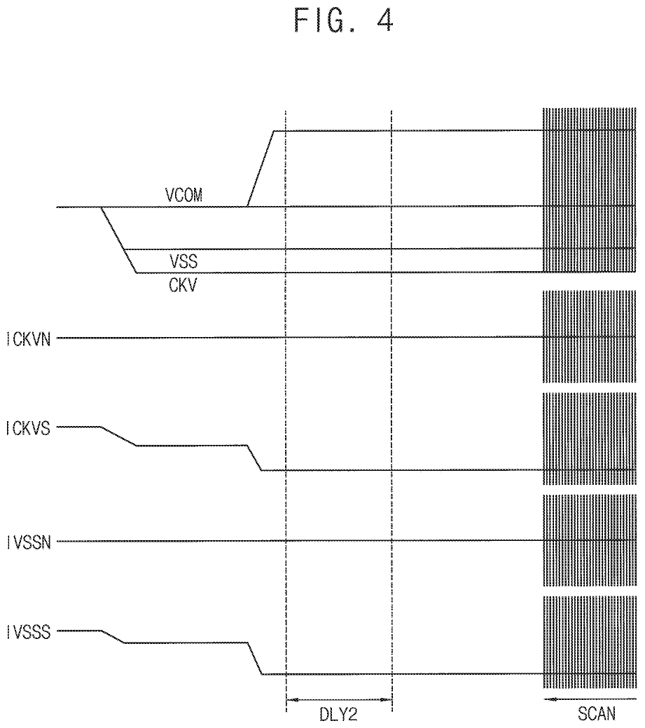

FIG. 3 is a timing diagram illustrating an input voltage and an output voltage of the power voltage generator 600 of FIG. 1. FIG. 4 is a timing diagram illustrating the input voltage, the output voltage, and a detected current of the power voltage generator 600 of FIG. 1.

Referring to FIGS. 1 to 4, the power voltage generator 600 may detect a level of the gate clock signal CKV before toggling the gate clock signal CKV and after turning on the display apparatus. When the gate clock signal CKV has an abnormal level (i.e., out of the normal range) before toggling the gate clock signal CKV and after turning on the display apparatus, the display apparatus changes a pattern of a power supply by limiting or stopping the power voltage provided to the display panel 100, the gate driver 300, and/or the data driver 500.

By detecting the level of the gate clock signal CKV before toggling the gate clock signal CKV and after turning on the display apparatus, the display apparatus can sensitively detect a short circuit between the adjacent gate lines GL and/or a short circuit between the gate line GL and the common electrode COM. Thus, the stability and reliability of the display apparatus may be enhanced.

For example, the power voltage generator 600 may detect a level of the gate clock signal CKV after the display apparatus is turned on and after the common voltage VCOM increases from an initial level to a level higher than the initial level, and the gate clock signal CKV decreases from the initial level to a level lower than the initial level.

In an initialization period, the gate-off voltage VOFF and the gate clock signal CKV may have the same level so that the gate-off voltage VOFF and the gate clock signal CKV are illustrated as a single waveform of “VOFF(CKV)” in FIG. 3. However, it is understood that the gate-off voltage VOFF and the gate clock signal CKV may different levels in other embodiments. After the gate clock signal CKV starts to toggle (in a SCAN period), the gate clock signal CKV swings between a gate-on voltage VON and a gate-off voltage VOFF, and the gate-off voltage VOFF maintains a uniform level.

Referring to FIG. 3, the power voltage generator 600 may decrease the gate-off voltage VOFF(CKV) in a first start period SS1 and maintain the level of the gate-off voltage VOFF(CKV) in a first delay period DLY1.

The power voltage generator 600 may increase the gate-on voltage VON to an input voltage VIN in a second start period SS2, increase the analog high voltage AVDD and the common voltage VCOM in a third start period SS3, and maintain the levels of the analog high voltage AVDD and the common voltage VCOM in a second delay period DLY2.

The power voltage generator 600 may increase the gate-on voltage VON from the input voltage VIN to a target level in a fourth start period SS4 and maintain the level of the gate-on voltage VON in a third delay period DLY3.

According to one embodiment, the power voltage generator 600 may detect a level of the gate clock signal CKV in the second delay period DLY2. In the second delay period DLY2, the levels of the common voltage VCOM and the gate clock signal CKV are stabilized, and a difference between the levels of the common voltage VCOM and the gate clock signal CKV has a maximum value. Thus, when an abnormal level of the gate clock signal CKV is detected in the second delay period DLY2, it is determined that a short circuit between the gate line GL and the common electrode COM may have occurred.

For example, the power voltage generator 600 may sense current flowing through the gate line GL to detect a level of the gate clock signal CKV. The power voltage generator 600 may receive the sensed current from the gate line GL of the display apparatus 100.

Referring to FIG. 4, when the gate clock signal CKV is in a normal range, a waveform of the sensed current may be represented as a sensed current ICKVN. In the second delay period DLY2, the gate clock signal CKV is not yet toggled and has a level of the gate-off voltage VOFF so that the waveform of the sensed current ICKVN may have a uniform level when the gate clock signal CKV is in the normal range.

In contrast, when the gate clock signal CKV is in an abnormal range out of the normal range, a waveform of the sensed current may be represented as a sensed current ICKVS. For example, the gate clock signal CKV being in the abnormal range may indicate that the short circuit may have occurred between the gate line GL and the common electrode COM. When the short circuit has occurred between the gate line GL and the common electrode COM, the waveform of the sensed current ICKVS may have a non-uniform level that changes in response to the change of the common voltage VCOM.

In the present example embodiment, the power voltage generator 600 may generate the second gate-off voltage VSS that is greater than the gate-off voltage VOFF. The gate-off voltage VOFF and the second gate-off voltage VSS may control an operation of the gate driver 300. For example, the gate-off voltage VOFF and the second gate-off voltage VSS may be used to turn off a switching element in a circuit of the gate driver 300.

The power voltage generator 600 may detect a level of the second gate-off voltage VSS after the display apparatus is turned on and before the gate clock signal CKV toggles. When the level of the second gate-off voltage VSS after turning on the display apparatus and before toggling the gate clock signal CKV has an abnormal level, the power voltage generator 600 may not provide power to the display apparatus.

The power voltage generator 600 may detect a level of second gate-off voltage VSS after the display apparatus is turned on and after the common voltage VCOM increases from the initial level to a level higher than the initial level and the second gate-off voltage VSS decreases from the initial level to a level lower than the initial level.

For example, the power voltage generator 600 may detect a level of the second gate-off voltage VSS in the second delay period DLY2 similarly to the gate clock signal CKV. In the second delay period DLY2, the levels of the common voltage VCOM and the second gate-off voltage VSS are stabilized. Thus, an abnormal level of the second gate-off voltage VSS in the second delay period DLY2 may be accurately detected.

For example, the power voltage generator 600 may sense a current flowing through an applying line of the second gate-off voltage VSS to detect a level of the second gate-off voltage VSS.

Referring to FIG. 4, when the second gate-off voltage VSS is in a normal range, a waveform of the sensed current may be represented as a sensed current IVSSN. In the second delay period DLY2, the second gate-off voltage VSS has a uniform level so that the waveform of the sensed current IVSSN may have a uniform level when the second gate-off voltage VSS is in the normal range.

In contrast, when second gate-off voltage VSS is in an abnormal range out of the normal range, a waveform of the sensed current may be represented as a sensed current IVSSS. For example, the second gate-off voltage VSS being in the abnormal range may indicate that the short circuit may have occurred between the applying line of the second gate-off voltage VSS and the common electrode COM. When the short circuit has occurred between the applying line of the second gate-off voltage VSS and the common electrode COM, the waveform of the sensed current IVSSS may have a non-uniform level that changes in response to the change of the common voltage VCOM.

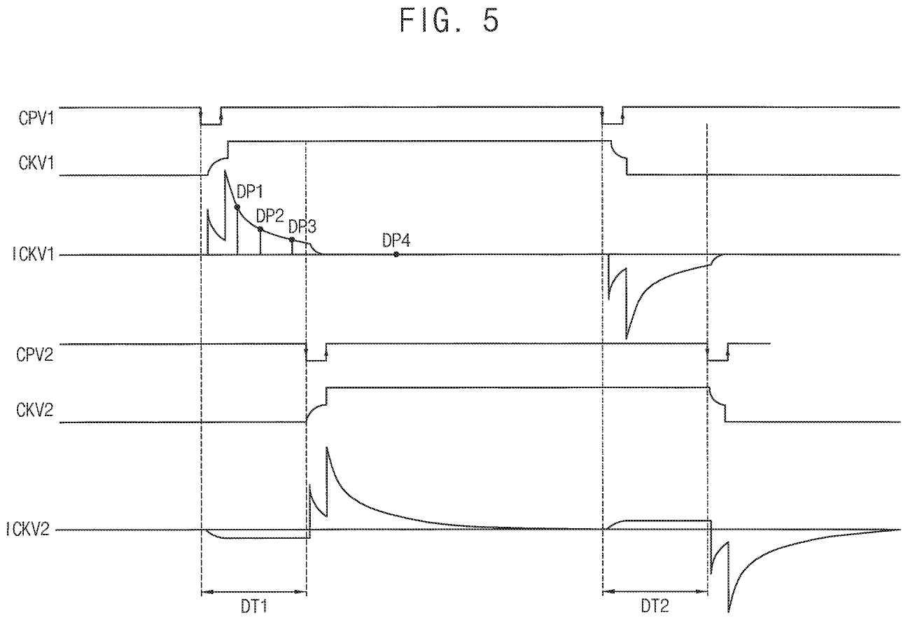

FIG. 5 is a timing diagram illustrating gate clock control signals CPV1 and CPV2, gate clock signals CKV1 and CKV2, and gate currents ICKV1 and ICKV2 of the gate driver 300 of FIG. 1.

Referring to FIGS. 1 to 5, the gate clock control signals CPV1 and CPV2 may be output from the driving controller 200 to the gate driver 300. For example, the gate clock control signals CPV1 and CPV2 may be included in the first control signal CONT1. In some embodiments, the gate clock control signals CPV1 and CPV2 may be output from the driving controller 200 to the power voltage generator 600.

The gate clock signals CKV1 and CKV2 may be synchronized with the gate clock control signals CPV1 and CPV2. A first gate clock signal CKV1 is a different signal from a second gate clock signal CKV2. A first gate clock control signal CPV1 is a different signal from a second gate clock control signal CPV2. A phase of a first gate clock signal CKV1 may be different from a phase of a second gate clock signal CKV2. A phase of a first gate clock control signal CPV1 may be different from a phase of a second gate clock control signal CPV2.

The power voltage generator 600 may detect a status of the gate clock signals CKV1 and CKV2 during a toggling period (e.g., in the SCAN period shown in FIGS. 3 and 4) in which the gate clock signals CKV1 and CKV2 swings between the gate-on voltage VON and the gate-off voltage VOFF.

If the status of the gate clock signals CKV1 and CKV2 is detected only before the toggling period, a short circuit may cause heat and/or fire during a use of the display apparatus.

In one embodiment, the power voltage generator 600 may detect levels of the gate clock signals CKV1 and CKV2 after a rising edge of the corresponding gate clock signals CKV1 and CKV2 and after a falling edge of the corresponding gate clock signals CKV1 and

CKV2 in the SCAN period.

In FIG. 5, a first detecting point DP1, a second detecting point DP2, a third detecting point DP3, and a fourth detecting point DP4 after a rising edge of a first gate clock signal CKV1 are illustrated. For example, the level of the first gate clock signal CKV1 may be detected at the first detecting point DP1, the second detecting point DP2, the third detecting point DP3, and the fourth detecting point DP4.

The power voltage generator 600 may detect a status of the gate clock signals CKV1 and CKV2 after the rising edge and after the falling edge of the gate clock signals CKV1 and CKV2 in the SCAN period and determine whether the gate clock currents ICKV1 and ICKV2 are within a normal range or not. For example, when the gate clock currents ICKV1 and ICKV2 are within a normal range after the rising edge and after the falling edge of the gate clock signals CKV1 and CKV2 in the SCAN period, the status of the gate clock signal CKV1 and CKV2 may be a normal status. When the gate clock currents ICKV1 and ICKV2 are within an normal range after the rising edge and after the falling edge of the gate clock signals CKV1 and CKV2 in the SCAN period, the status of the gate clock signal CKV1 and CKV2 may be an abnormal status.

When the detected currents ICKV1 and ICKV2 of the gate clock signals CKV1 and CKV2 are out of a predetermined range, the power voltage generator 600 may determine that the gate clock signals CKV1 and CKV2 have an abnormal level. In contrast, when the detected currents ICKV1 and ICKV2 of the gate clock signals CKV1 and CKV2 are within the predetermined range, the power voltage generator 600 may determine that the gate clock signals CKV1 and CKV2 have a normal level.

In one example embodiment, the power voltage generator 600 may detect levels of the gate clock signals CKV1 and CKV2 right before a rising edge (e.g., in a first detection period DT1) of the gate clock signals CKV1 and CKV2 and right before a falling edge (e.g., in a second detection period DT2) of the gate clock signals CKV1 and CKV2 in the toggling period (the SCAN period) of the gate clock signal CKV1 and CKV2.

In one embodiment, the power voltage generator 600 may determine whether the gate clock currents ICVK1 and ICKV2 are less than a normal-off voltage level right before the rising edge of the gate clock signals CKV1 and CKV2. In the example of FIG. 5, a second gate clock current ICKV2 of the second gate clock signal CKV2 may be sensed right before the rising edge (e.g., in the first detection period DT1) of the second gate clock signal CKV2. In this case, because the second gate clock current ICKV2 sensed right before the rising edge of the second gate clock signal CKV2 is less than the normal-off voltage level, the power voltage generator 600 may determine that a gate line GL that applies the second gate clock signal CKV2 and another signal line (e.g., another gate line GL or the common electrode COM) are shorted with each other.

In one embodiment, the power voltage generator 600 may determine whether the gate clock currents ICVK1 and ICKV2 are greater than the normal-off voltage level right before the falling edge of the gate clock signals CKV1 and CKV2. In the example of FIG. 5, the second gate clock current ICKV2 of the second gate clock signal CKV2 may be sensed right before the falling edge (e.g., in the second detection period DT2) of the second gate clock signal CKV2. In this case 5, because the second gate clock current ICKV2 sensed right before the falling edge of the second gate clock signal CKV2 is greater than the normal-off voltage level, the power voltage generator 600 may determine that a gate line GL that applies the second gate clock signal CKV2 and another signal line (e.g., another gate line GL or the common electrode COM) are shorted with each other.

According to the present example embodiment, a level of the gate clock signal CKV is firstly detected before toggling the gate clock signal CKV and after turning on the display apparatus so that an abnormal level of the gate clock signal may be sensitively detected. The detected abnormal level of the gate clock signal CKV may indicate that a short circuit may exist, and it may be used to prevent heat and/or fire by stopping a power supply to the display apparatus. In addition, the abnormal level of the gate clock signal CKV may be secondly and thirdly detected after toggling the gate clock signal CKV, thereby enhancing the stability and reliability of the display apparatus.

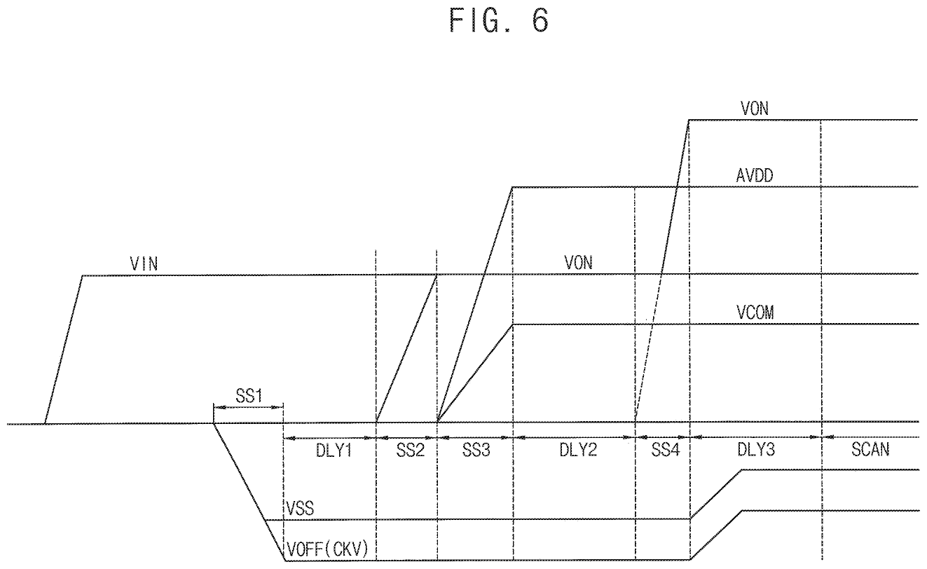

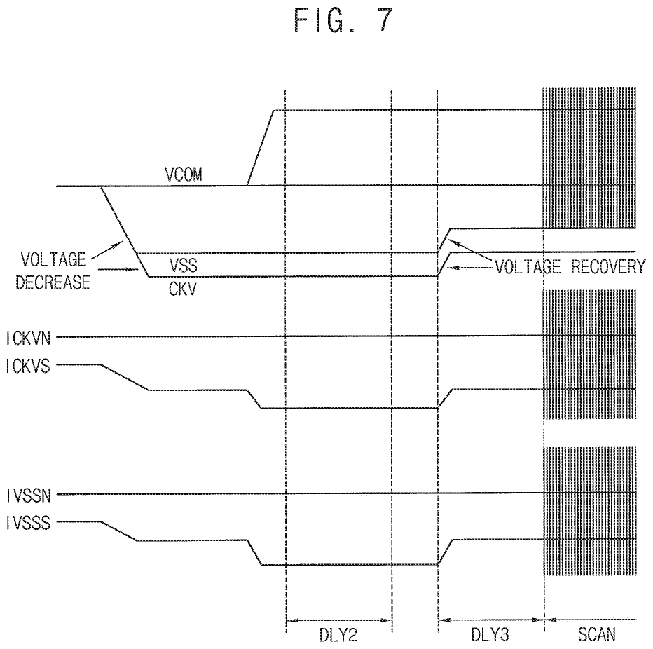

FIG. 6 is a timing diagram illustrating an input voltage and an output voltage of a power voltage generator 600 of a display apparatus according to an example embodiment of the present inventive concept. FIG. 7 is a timing diagram illustrating the input voltage, the output voltage and a detected current of the power voltage generator 600 of FIG. 6.

The display apparatus and the method of driving the display apparatus according to the present example embodiment is substantially the same as the display apparatus and the method of driving the display apparatus of the previous example embodiment explained referring to FIGS. 1 to 5 except for the level of the gate clock signal CKV, the gate-off voltage VOFF, and the second gate-off voltage VSS. Thus, the same reference numerals will be used to refer to the same or like parts/signals as those described in the previous example embodiment of FIGS. 1 to 5, and any repetitive explanation concerning the above elements will be omitted.

Referring to FIGS. 1, 2, and 5 to 7, the display apparatus includes the display panel 100 and the display panel driver. The display panel driver includes the driving controller 200, the gate driver 300, the gamma reference voltage generator 400, and the data driver 500. The display panel driver may further include the power voltage generator 600.

The power voltage generator 600 may provide a power voltage to at least one of the display panel 100, the driving controller 200, the gate driver 300, the gamma reference voltage generator 400, and the data driver 500. In one embodiment, the power voltage generator 600 may include a DC-to-DC converter.

The power voltage generator 600 may detect a level of the gate clock signal CKV before toggling the gate clock signal CKV and after turning on the display apparatus. When the gate clock signal CKV has an abnormal level (i.e., out of the normal range) before toggling the gate clock signal CKV and after turning on the display apparatus, a pattern of the power supply in the display apparatus may be changed by limiting or stopping the power voltage provided to the display panel 100, the gate driver 300, and/or the data driver 500.

For example, the power voltage generator 600 may detect a level of the gate clock signal CKV after the display apparatus is turned on and after the common voltage VCOM increases from an initial level to a level higher than the initial level and the gate clock signal CKV decreases from the initial level to a level lower than the initial level.

According to one embodiment, the power voltage generator 600 may detect a level of the gate clock signal CKV in the second delay period DLY2. In the second delay period DLY2, the levels of the common voltage VCOM and the gate clock signal CKV are stabilized, and a difference between the levels of the common voltage VCOM and the gate clock signal CKV has a maximum value. Thus, when an abnormal level of the gate clock signal CKV is detected in the second delay period DLY2, it is determined that a short circuit between the gate line GL and the common electrode COM may have occurred.

In the present example embodiment, the power voltage generator 600 may decrease the gate clock signal CKV from the initial level to a first level that is lower than the initial level and detect the level of the gate clock signal CKV. The power voltage generator 600 may increase the gate clock signal CKV from the first level to a second level that is higher than the first level and lower than the initial level after detecting the level of the gate clock signal CKV.

According to one embodiment, the gate clock signal CKV may be further decreased than a normal level (or the second level) of the gate clock signal CKV when detecting the level of the gate clock signal CKV so that the difference of the levels of the common voltage VCOM and the gate clock signal CKV may be increased (indicated as VOLTAGE DECREASE in FIG. 7). Thus, a short circuit that may have occurred between the gate line GL and the common electrode COM may be further accurately detected.

The power voltage generator 600 may increase the gate-on voltage VON from the input voltage VIN to a target level in the fourth start period SS4 and maintains the target level of the gate-on voltage VON in the third delay period DLY3.

The power voltage generator 600 may increase the gate clock signal CKV from the first level to the second level in the third delay period DLY3 (indicated as VOLTAGE RECOVERY in FIG. 7). The second level may be the normal level of the gate clock signal CKV.

Similarly, the power voltage generator 600 may decrease the second gate-off voltage VSS from the initial level to a third level that is lower than the initial level and detect the level of the second gate-off voltage VSS. The power voltage generator 600 may increase the second gate-off voltage VSS from the third level to a fourth level that is higher than the third level and lower than the initial level after detecting the level of the second gate-off voltage VSS.

According to one embodiment, the second gate-off voltage VSS may be further decreased than a normal level (or the fourth level) of the second gate-off voltage VSS when detecting the level of the second gate-off voltage VSS so that the difference of the level of the common voltage VCOM and the level of the second gate-off voltage VSS may be increased (indicated as VOLTAGE DECREASE in FIG. 7). Thus, a short circuit that may have occurred between the applying line of the second gate-off voltage VSS and the common electrode COM may be further accurately detected.

The power voltage generator 600 may increase the second gate-off voltage VSS from the third level to the fourth level in the third delay period DLY3 (indicated as VOLTAGE RECOVERY in FIG. 7). The fourth level may be the normal level of the second gate-off voltage VSS.

According to the present example embodiment, a level of the gate clock signal CKV is firstly detected before toggling the gate clock signal CKV and after turning on the display apparatus so that the abnormal level of the gate clock signal may be sensitively detected. The detected abnormal level of the gate clock signal CKV may indicate that a short circuit may exist, and it may be used to prevent heat and/or fire by stopping a power supply to the display apparatus. In addition, the abnormal level of the gate clock signal CKV may be secondly and thirdly detected after toggling the gate clock signal CKV, thereby enhancing the stability and reliability of the display apparatus.

According to the present inventive concept as explained above, the stability and reliability of the display apparatus may be enhanced.

The foregoing is illustrative of the present inventive concept and is not to be construed as limiting thereof. Although some example embodiments of the present inventive concept have been described, those skilled in the art will readily appreciate that various modifications are possible in the example embodiments without materially departing from the novel teachings and advantages of the present inventive concept. Accordingly, such modifications are intended to be included within the scope of the present inventive concept. In the claims, means-plus-function clauses are intended to cover the structure(s) described herein as performing the recited function and not only structural equivalents but also equivalent structures. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the present disclosure. The present inventive concept is defined by the following claims, with equivalents of the claims to be included therein.

What is claimed is:

1. A display apparatus comprising:
a display panel comprising a gate line and a data line;
a gate driver connected to the gate line;
a data driver connected the data line; and
a power voltage generator configured to provide a power voltage to at least one of the display panel, the gate driver, and the data driver,
wherein the power voltage generator is further configured to generate a gate-on voltage, a gate-off voltage, and a gate clock signal toggling between the gate-on voltage and the gate-off voltage, and
wherein the power voltage generator is further configured to detect a voltage level of the gate clock signal before toggling the gate clock signal and after turning on the display apparatus and change a supply pattern of the power voltage based on the gate clock signal having a first abnormal voltage level out of a first predetermined normal range.

2. The display apparatus of claim 1, wherein the power voltage generator is further configured to detect the voltage level of the gate clock signal after the display apparatus is turned on and after a common voltage applied to the display panel increases from an initial voltage level, and the gate clock signal decreases from the initial voltage level to a first voltage level lower than the initial voltage level.

3. The display apparatus of claim 2, wherein the power voltage generator is further configured to decrease the gate-off voltage in a first start period, maintain a voltage level of the gate-off voltage in a first delay period, increase the gate-on voltage to an input voltage in a second start period, increase an analog high voltage and the common voltage in a third start period, and maintain voltage levels of the analog high voltage and the common voltage in a second delay period, and
wherein the power voltage generator is further configured to detect the voltage level of the gate clock signal in the second delay period.

4. The display apparatus of claim 3, wherein the power voltage generator is further configured to detect the voltage level of the gate clock signal after decreasing the gate clock signal from the initial voltage level to the first voltage level, and
wherein the power voltage generator is further configured to increase the gate clock signal from the first voltage level to a second voltage level that is higher than the first voltage level and lower than the initial voltage level after detecting the voltage level of the gate clock signal.

5. The display apparatus of claim 4, wherein the power voltage generator is further configured to increase the gate-on voltage from the input voltage to a target voltage level in a fourth start period and maintain the target voltage level of the gate-on voltage in a third delay period, and
wherein the power voltage generator is further configured to increase the gate clock signal from the first voltage level to the second voltage level in the third delay period.

6. The display apparatus of claim 2, wherein the power voltage generator is further configured to detect the voltage level of the gate clock signal using a current flow through the gate line.

7. The display apparatus of claim 2, wherein the power voltage generator is further configured to detect the voltage level of the gate clock signal after a rising edge of the gate clock signal and after a falling edge of the gate clock signal after the gate clock signal starts toggling.

8. The display apparatus of claim 7, wherein the power voltage generator is further configured to detect a status of the gate clock signal after the rising edge of the gate clock signal and after the falling edge of the gate clock signal based on a gate clock current flowing through the gate line.

9. The display apparatus of claim 7, wherein the power voltage generator is further configured to detect the voltage level of the gate clock signal right before the rising edge of the gate clock signal and right before the falling edge of the gate clock signal after the gate clock signal starts toggling.

10. The display apparatus of claim 9, wherein the power voltage generator is further configured to determine whether a gate clock current flowing through the gate line is less than a normal-off voltage level right before the rising edge of the gate clock signal.

11. The display apparatus of claim 10, wherein the power voltage generator is further configured to determine whether the gate clock current is greater than the normal-off voltage level right before the falling edge of the gate clock signal.

12. The display apparatus of claim 1, wherein the power voltage generator is further configured to generate a second gate-off voltage greater than the gate-off voltage and
wherein the power voltage generator is further configured to change a supply pattern of the power voltage based on the second gate-off voltage having a second abnormal voltage level out of a second predetermined normal range.

13. The display apparatus of claim 12, wherein the power voltage generator is further configured to detect a voltage level of the second gate-off voltage after the display apparatus is turned on and after a common voltage applied to the display panel increases from an initial voltage level, and the second gate-off voltage decreases from the initial voltage level to a first voltage level lower than the initial voltage level.

14. The display apparatus of claim 13, wherein the power voltage generator is further configured to decrease the gate-off voltage in a first start period, maintain a voltage level of the gate-off voltage in a first delay period, increase the gate-on voltage to an input voltage in a second start period, increase an analog high voltage and the common voltage in a third start period, and maintain voltage levels of the analog high voltage and the common voltage in a second delay period, and
wherein the power voltage generator is configured to detect the voltage level of the second gate-off voltage in the second delay period.

15. The display apparatus of claim 14, wherein the power voltage generator is further configured to detect the voltage level of the second gate-off voltage after decreasing the second gate-off voltage from the initial voltage level to a third voltage level, and
wherein the power voltage generator is further configured to increase the second gate-off voltage from the third voltage level to a fourth voltage level that is higher than the third voltage level and lower than the initial voltage level after detecting the voltage level of the second gate-off voltage.

16. The display apparatus of claim 15, wherein the power voltage generator is further configured to increase the gate-on voltage from the input voltage to a target voltage level in a fourth start period and maintain the target voltage level of the gate-on voltage in a third delay period, and
wherein the power voltage generator is further configured to increase the second gate-off voltage from the third voltage level to the fourth voltage level in the third delay period.

17. The display apparatus of claim 13, wherein the power voltage generator is further configured to detect the voltage level of the second gate-off voltage using a current flow through an applying line of the second gate-off voltage in the gate driver.

18. A method of driving a display apparatus, the method comprising:
generating a gate-on voltage;
generating a gate-off voltage;
generating a gate clock signal toggling between the gate-on voltage and the gate-off voltage;
detecting a voltage level of the gate clock signal before toggling the gate clock signal and after turning on the display apparatus; and
changing a supply pattern of a power voltage of the display apparatus based on the gate clock signal having an abnormal voltage level out of a predetermined normal range.

19. The method of claim 18, wherein the voltage level of the gate clock signal is detected after the display apparatus is turned on and after a common voltage applied to a display panel of the display apparatus increases from an initial voltage level, and the gate clock signal decreases from the initial voltage level.

20. The method of claim 19, further comprising decreasing the gate-off voltage in a first start period, maintaining a voltage level of the gate-off voltage in a first delay period, increasing the gate-on voltage to an input voltage in a second start period, increasing an analog high voltage and the common voltage in a third start period, and maintaining voltage levels of the analog high voltage and the common voltage in a second delay period, and
wherein the voltage level of the gate clock signal is detected in the second delay period.
